(19) United States
(12) Patent Application Publication
(10) Pub. No.: US 2018/0236646 A1
(43) Pub. Date: Aug. 23, 2018

(54) FUEL GAS-FIRED DRIVING-IN TOOL HAVING A VALVE MEMBER

(71) Applicant: Hilti Aktiengesellschaft, Schaan (LI)

(72) Inventors: Klaus RAGGL, Zuerich (CH); Christoph BOEHM, Gams (CH)

(21) Appl. No.: 15/753,011

(22) PCT Filed: Sep. 6, 2016
(86) PCT No.: PCT/EP2016/070923

§ 371 Date: Feb. 15, 2018

(30) Foreign Application Priority Data
Sep. 14, 2015 (EP) 15185077.3

(51) Int. Cl. B25C 1/08; B25C 1/00; B25C 1/04

(52) U.S. Cl. CPC B25C 1/085; B25C 1/008; B25D 2250/121; B25C 1/046; B25C 1/047

(57) ABSTRACT

The invention relates to a driving-in tool, comprising a driving-in piston, guided in a cylinder, for driving a nail element into a workpiece, and a combustion chamber which is arranged at the driving-in piston and can be filled with an ignitable fuel-gas mixture. A positive pressure of the fuel-gas mixture in the combustion chamber can be produced by a movement of the driving-in piston. At least one of the two, the combustion chamber or the cylinder, is connected to an external space via a valve member, the positive pressure of the fuel-gas mixture produced by the driving-in piston being selectively adjustable by means of the valve member.

The invention relates to a nail gun, in particular a manually controlled nail gun in accordance with the preamble of claim 1.

WO 2012/046217 A1 describes a nail gun in which a driving piston is moved by means of a drive with the production of a positive pressure against a combustion chamber. This allows an increase in the driving energy with the same combustion chamber size.

WO 2009/140728 A1 describes a combustible gas driven nail gun for driving a nail into a workpiece, in which a combustion chamber is charged with a combustible gas, wherein after an ignition process, a driving piston is accelerated against the nail. The combustible gas can be charged by combined measures by means of a fan as well as the stroke of the driving piston to a positive pressure so as to achieve an increase in the driving energy.

DE 40 10 517 A1 shows a conventional, uncharged nail gun. A driving energy can be influenced via an adjustable exhaust valve over which a part of the combusted and expanded gas escapes during the piston acceleration.

It is the problem of the invention to provide a nail gun that has great flexibility in the choice of a driving energy.

This problem is solved for an above-named nail gun according to the invention with the characterizing features of claim 1. By provision of the valve element, the positive pressure present prior to the ignition can be adjusted in a simple manner to an intermediate value below a maximal pressure.

A positive pressure of the combustible gas mix in the sense of the invention is understood to be a pressure for increasing the driving energy. Even in conventional, uncharged devices, the pressure of the combustible gas mix is usually somewhat above an ambient pressure, as the combustible gas under pressure is added to the air in the combustion chamber under atmospheric pressure. This is only a slight pressure increase. A positive pressure in the sense of the invention preferably is around at least 100 mbar, especially preferably around at least 200 mbar above the atmospheric pressure.

A valve element in the sense of the invention closes or opens a connection between the combustion chamber and/or the cylinder and an external space. In the sense of the invention the valve element is not understood to be a movable combustion chamber part, the movement of which first forms the combustion chamber.

In a generally advantageous embodiment of the invention, the combustion chamber comprises at least combustion chamber parts movable toward one another, wherein the combustion chamber parts are combined into the closed combustion chamber only when the nail gun is in a compressed state. Devices of this design are generally known and due to their construction are quite safe with respect to inadvertent or improper triggering. In a preferred, detailed design of the invention, the combustion chamber parts are moved toward one another via a compression rod.

In a preferred embodiment of the invention, the valve element is configured as a switching valve connected to the combustion chamber. This permits in particular a continuous setting of the positive pressure over a wide range. A switching valve preferably is understood to be an electrically controlled switching valve that has at least the two states “open” and “closed.”

In a preferred further embodiment, switching of the valve element occurs depending on a position of the driving piston. In this way the achieved positive pressure is connected to the site of start of a compressing piston motion, wherein the previous piston motion effects no compression because of the opened valve. Alternatively or additionally, however a time control of the valve element can also occur. With the accordingly known cross section of the valve element and size of the combustion chamber, a targeted pressure reduction can then be achieved in the combustion chamber.

In a further possible embodiment, switching of the valve element depending on a measurement by means of a pressure sensor takes place. On the one hand, the pressure makes an additional component necessary; on the other, however, the desired pressure can be set especially accurately and reliably.

In a further possible embodiment of the invention, the valve element can be formed as an adjustable postoperative valve. This allows for example a simple implementation by means of spring mechanics on the valve element. In order to avoid or reduce a partial exhaust of the higher combustion pressure after ignition of the combustible gas mix, such a valve element can be provided with an additional, pressure-safe closing function. Alternatively thereto, the valve element can also be provided with an accordingly small cross section, which leads only to a slight pressure loss during a driving process. Here the circumstance can be used that the return or compression process usually proceeds considerably slower than the combustion or driving process.

In an alternative or additional solution to the above-named embodiments, the valve element is configured as at least one opening selectable, closable opening arranged on the cylinder. In the case of the opened valve element, the driving piston can be moved compression-free to the opening. After the piston passes over the opening, the compression begins. It is understood that several valve elements or selectable closable openings can be arranged one after another in the longitudinal direction of the cylinder, so that a correspondingly multistep setting of the compression path or the positive pressure is made possible. However, the valve element can also be a slot-like opening in the cylinder wall, which for example may be covered continuously by means of a displaceable outer sleeve.

Generally advantageously the valve element can be controlled via an electronic control unit of the nail gun. Alternatively, however, it can also be a mechanical control with manual operation. Especially simply, a mechanical control can be implemented by means of an adjustable positive pressure valve or by means of a selectably closeable opening provided in the cylinder wall.

In a generally preferred embodiment of the invention, the driving piston for producing the positive pressure is adjustable via an electrical drive. The mechanical work of compression or charging of the combustible gas to a positive pressure is hereby performed by the drive. This allows a high frequency of setting processes.

In a possible embodiment of the invention, in addition a further charging element, preferably an electrically driven compressor, is provided for acting on the combustion chamber with a positive pressure of the combustible gas mix. Such a device thus has not only an inner charge by means of the movement of the driving piston, but also an external charge by means of a further charging element. This permits, when needed, charging with an even higher positive pressure, so that an especially broad adjustability of the driving energy is made possible.

Further advantages and features of the invention follow from the following described exemplary embodiments as well as the dependent claims.

Below several preferred exemplary embodiments of the invention are described and described in closer detail with reference to the enclosed drawings.

FIG. 1 shows a schematic sectional view of a nail gun according to the invention of a first exemplary embodiment with electrically controlled valve element in the region of a combustion chamber in open state.

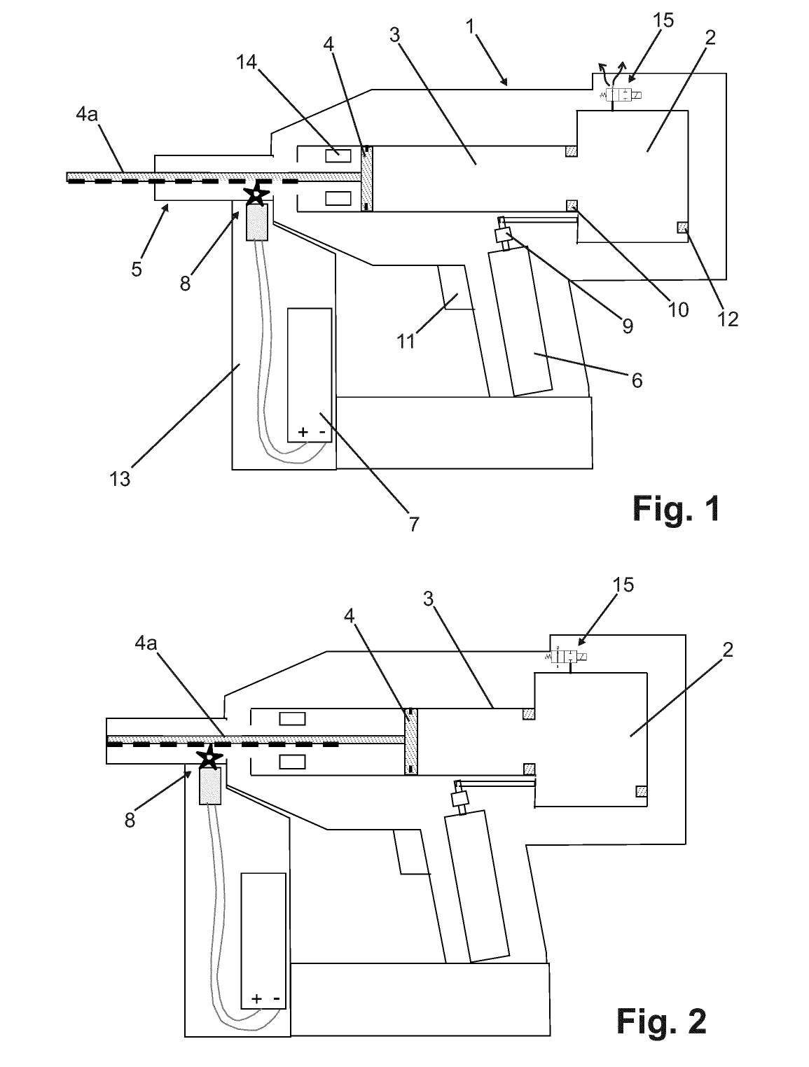

FIG. 2 shows a nail gun from FIG. 1 in s second operating state after closing of the valve element.

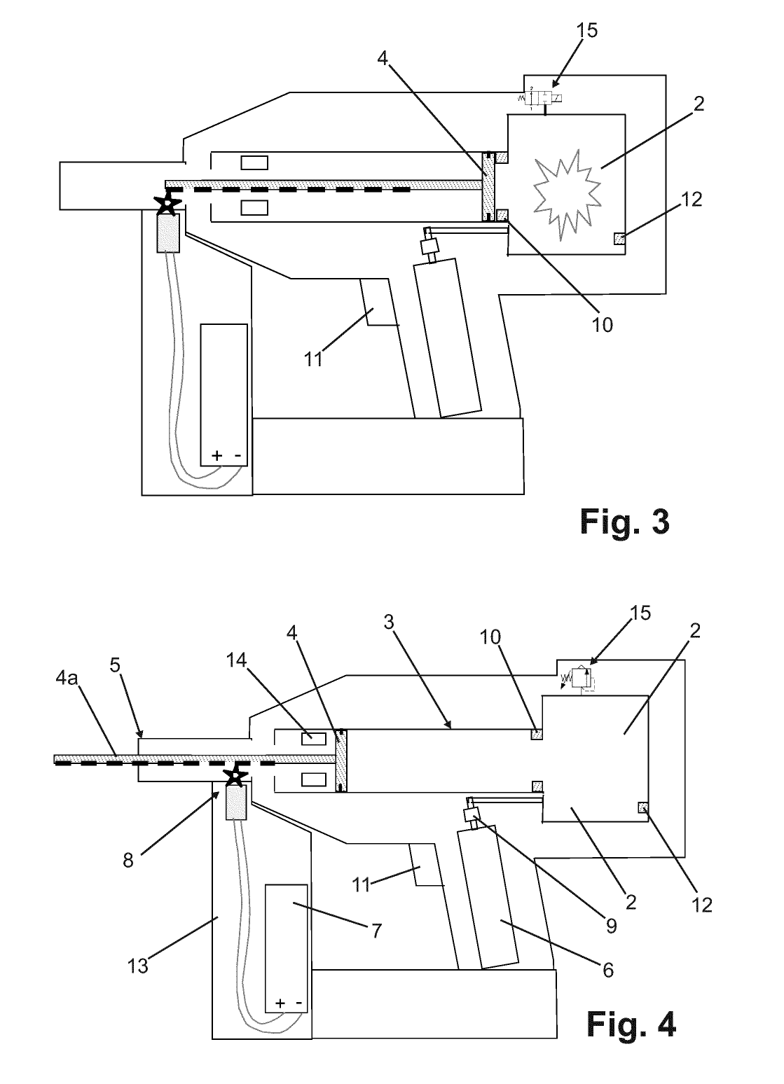

FIG. 3 shows the nail gun from FIG. 1 in a third operating state at the time of ignition.

FIG. 4 shows a schematic sectional view of a nail gun according to the invention of a second exemplary embodiment with adjustable pressure limiting valve.

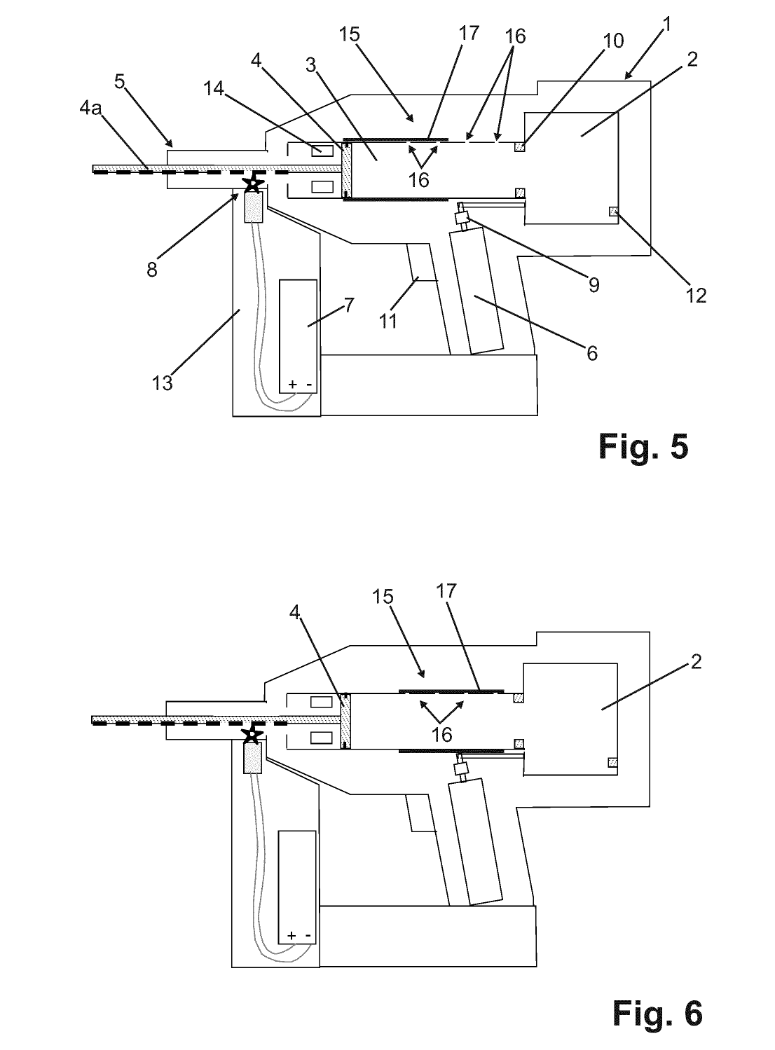

FIG. 5 shows a schematic sectional view of a nail gun according to the invention of a third exemplary embodiment with a valve element in the region of a cylinder.

FIG. 6 shows the nail gun from FIG. 5, wherein the valve element is set to a maximal driving energy.

The nail gun from FIG. 1 is a manually controlled device comprising a housing 1 and a combustion chamber 2 accommodated therein with a combustion chamber wall. A cylinder 3 abuts the combustion chamber 2 with a driving piston 4 guided therein.

A safety mechanism of the device comprises a compression rod with mounting sleeve 5, which is mounted on a workpiece (not shown) and is pushed against the pressure of a spring (not shown). Only in this state can a driving process be triggered by ignition of a combustible gas in the combustion chamber 2. The combustion chamber 2 consists of several combustion chamber parts (not shown) that are movable toward one another, which only after pressing of the mounting sleeve 5 via the compression rod are combined into a closed space for receiving an ignitable combustible gas mix. Such designs of combustion chambers with the purpose of safety improvement are generally known, for example from the above-named publications. A detailed representation of these safety mechanisms in the present schematic drawings was therefore dispensed with.

An ignitable combustible gas mix is presently fed by means of a combustible gas container into the combustion chamber 2. The combustible gas is hereby compressed to a positive pressure following return of the driving piston 4. The driving piston 4 driven in its return by an electrical drive 8 supplied by a battery 7, which engages the driving member 4a of the driving piston 4.

The combustible gas is fed by a dispensing valve 9 from the combustible gas container 6 to the air of the combustion chamber 2. The combustible gas injection can take place depending on requirements into still non-compressed, partially compressed, or even fully compressed air.

In fully returned state (see FIG. 3), the driving piston 4 is held by a magnetic holder 10 against the positive pressure in the combustion chamber.

When the combustion chamber is charged, via a manually actuated trigger 11, ignition of the combustible gas mix can be initiated via a spark plug 12, so that the driving piston 4 is driven forward and via the driving member 4a, drives a nail element (not shown from a magazine into the workpiece. The exhaust cases of the ignited and expanded combustible gas can exit into the external space at the end of the path of the driving piston via the outlet openings 14.

The positive pressure achieved in the combustion chamber 2 by return of the driving piston can be selectably set by means of a valve element 15 arranged in the combustion chamber 2. Presently the valve element 15 is configured as an electrically actuated switching valve that is connected to an electronic control unit of the nail gun. By setting by an operator, a driving energy in a given scope is preselected. Dependent on this, the valve element is either permanently closed (maximal compression and driving energy) or is closed only after a specific stroke of the driving piston on its return path.

In the state according to FIG. 1, the valve element 15 is still in an opened state, while the driving piston is also moved in the direction of the combustion chamber. In this way air escapes through the valve element 15 (shown by arrow) and there is still no compression.

In the state according to FIG. 2, the driving piston has moved by around a half stroke. In this position according to the selection by the operator, the valve element 15 is closed and the buildup of the positive pressure starts in the combustion chamber.

FIG. 3 shows the fully returned driving piston 4, which still lies against the magnetic holder 10, while the ignition process is initiated by actuation of the trigger 11.

In the second exemplary embodiment according to FIG. 4, the valve element 15 is not configured as in the first exemplary embodiment as an electrically controlled switching valve, but as an adjustable positive pressure valve or pressure regulating valve. This type of valve also permits, for example, a purely mechanical preselection of the positive pressure by the operator.

Depending on the pretensioning or setting of the positive pressure valve, opening occurs as soon as the positive pressure achieved by the driving piston is above the set threshold.

Preferably the positive pressure valve is also completely closed when the ignition of the combustible gas mix occurs. This can be implemented for example by a second switching state or an additional valve connected in series (not shown). Since the expansion process of the ignited combustible gas usually occurs much faster than the compression process, however, depending on demands it can also be sufficient to dimension the positive pressure valve with an accordingly small outlet cross section.

In the previous exemplary embodiments, the valve element 15 is in each case arranged on the combustion chamber or directly connected to it. In the following described third exemplary embodiment according to FIG. 5 to FIG. 6, the valve element 15 is arranged on the cylinder 3.

For this purpose, a wall of the cylinder 3 is provided with several openings 16 spaced apart from one another in the longitudinal direction of the cylinder. A valve slide, herein in the shape of a sleeve 17, can selectably close the openings 16. The result is that the driving piston 4 depending on the position of the valve slide 17 starts at different positions with the compression.

In FIG. 5, the valve slide 17 is positioned such that the opening positioned closest to the combustion chamber is not closed. This results in a maximally late compression of the driving piston in its return path and thus to a minimal positive pressure.

In FIG. 6, the valve slide 17 positioned such that all openings 16 are covered. This results in compression over the entire path of the driving piston and therefore to maximal positive pressure and maximal driving energy.

It is understood that depending on the number and arrangement of the openings 16, arbitrary levels of driving energy can be achieved. Through a slotted opening in the cylinder longitudinal direction, in principle a continuous setting of the driving energy can occur.

The individual features of the different exemplary embodiments can be combined reasonably with one another depending on requirements.

1. A nail gun for driving a nail element into a workpiece comprising
a driving piston guided in a cylinder; and
a combustion chamber which is arranged on the driving piston and may be charged with an ignitable combustible gas mix;
wherein by motion of the driving piston, a positive pressure can be produced in the ignitable combustible gas mix in the combustion chamber;
wherein
the combustion chamber and/or the cylinder is connected via a valve element to an exterior space, wherein the positive pressure of the combustible gas mix produced by the driving piston is selectably adjustable by the valve element.

2. The nail gun according to claim 1, wherein the valve element is configured as a switching valve connected to the combustion chamber.

3. The nail gun according to claim 2, wherein switching of the valve element depends on a position of the driving piston.

4. The nail gun according to claim 2, wherein switching of the valve element occurs depending on a measurement with a pressure sensor.

5. The nail gun according to claim 1, wherein the valve element is configured as an adjustable positive pressure valve.

6. The nail gun according to claim 1, wherein the valve element is configured as at least one selectably closable opening arranged on the cylinder.

7. The nail gun according to claim 1, wherein the valve element may be controlled via an electronic control unit of the nail gun.

8. The nail gun according to claim 1, wherein the driving piston may be adjusted to produce the positive pressure via an electrical drive.

9. The nail gun according to claim 1, further comprising an additional charging element, provided to act on the combustion chamber with a positive pressure of the ignitable combustible gas mix.

10. The nail gun according to claim 9, wherein the additional charging element comprises an electrically driven compressor.

11. The nail gun according to claim 3, wherein switching of the valve element occurs depending on a measurement with a pressure sensor.

12. The nail gun according to claim 2, wherein the valve element is configured as an adjustable positive pressure valve.

13. The nail gun according to claim 3, wherein the valve element is configured as an adjustable positive pressure valve.

14. The nail gun according to claim 4, wherein the valve element is configured as an adjustable positive pressure valve.

15. The nail gun according claim 2, wherein the valve element is configured as at least one selectably closable opening arranged on the cylinder.

16. The nail gun according claim 3, wherein the valve element is configured as at least one selectably closable opening arranged on the cylinder.

17. The nail gun according claim 4, wherein the valve element is configured as at least one selectably closable opening arranged on the cylinder.

18. The nail gun according claim 5, wherein the valve element is configured as at least one selectably closable opening arranged on the cylinder.

19. The nail gun according to claim 2, wherein the valve element may be controlled via an electronic control unit of the nail gun.

20. The nail gun according to claim 3, wherein the valve element may be controlled via an electronic control unit of the nail gun.
